(19) United States
(12) Patent Application Publication
(10) Pub. No.: US 2021/0024227 A1
(43) Pub. Date: Jan. 28, 2021

(54) WORKLOAD CALCULATION SYSTEM

(71) Applicant: TOYOTA JIDOSHA KABUSHIKI KAISHA, Toyota-shi (JP)

(72) Inventors: Ikuo OHTA, Toyota-shi (JP); Hideshi MIZUTANI, Toyota-shi (JP); Atsushi SAJIKI, Okazaki-shi (JP); Takao INATA, Tokyo-to (JP); Yohei TANIGAWA, Toyota-shi, Aichi-ken (JP); Atsushi NAKAJIMA, Kariya-city (JP); Atsuo KOMATSUBARA, Nagakute-shi (JP)

(21) Appl. No.: 16/929,178

(22) Filed: Jul. 15, 2020

(30) Foreign Application Priority Data
Jul. 26, 2019 (JP) 2019-137817

(51) Int. Cl. B64F 1/36; G08G 5/00

(52) U.S. Cl. CPC B64F 1/368; B64F 1/366; G08G 5/0082; G08G 5/0013; G08G 5/0043

(57) ABSTRACT

To provide a workload calculation system capable of suppressing the possibility of the cargo handling work not being performed as planned in the work schedule at the arrival airport. A workload calculation system according to the present disclosure includes: an image pick-up unit configured to acquire an image of a cargo loaded aboard an airplane prior to the arrival of the airplane at an arrival airport; a characteristics detection unit configured to detect characteristics of the cargo by recognizing the image of the cargo acquired by the image pick-up unit; and a workload calculation unit configured to calculate a workload required to convey the cargo at the arrival airport by checking the characteristics of the cargo detected by the characteristics detection unit against pre-recorded workload information.

### CROSS REFERENCE TO RELATED APPLICATIONS

This application is based upon and claims the benefit of priority from Japanese patent application No. 2019-137817, filed on Jul. 26, 2019, the disclosure of which is incorporated herein in its entirety by reference.

### BACKGROUND

The present disclosure relates to a workload calculation system.

A technique of enhancing the distribution efficiency at an airport has been under discussion. Japanese Unexamined Patent Application Publication No. 2002-321699 discloses a technique of conveying air cargo underground by connecting an air cargo storage area at an airport terminal building and a hardstand through a carbo conveyance mechanism provided underground and further, connecting the ground and a conveying position at which the air cargos are conveyed into/out from the cargo conveyance mechanism through an elevator for air cargo.

### SUMMARY

Conventionally, at an arrival airport, the amount of workload required to convey air cargos such as luggage loaded aboard the arriving airplane has been estimated manually as the cargo handling amount. Further, a work schedule has been planned based on the estimated handling amount.

However, some airplanes have cargos loaded aboard without having them stacked in a container or on a pallet, and thus the cargos are loaded in bulk (i.e., individually). This kind of airplane can be specifically seen among those arriving from Asia.

As described above, in the case of an airplane aboard which the cargos are loaded in bulk, when the characteristics such as the shape etc. of the cargos vary largely, an unexpected amount of workload is required at the arrival airport depending on the characteristics of the cargos. Therefore, there has been a possibility that the cargo handling work may not be performed as planned in the work schedule at the arrival airport.

The present disclosure has been made in view of the background mentioned above and provides a workload calculation system capable of suppressing the possibility of the cargo handling work not being performed as planned in the work schedule at the arrival airport.

A workload calculation system according to an aspect of the present disclosure includes:

an image pick-up unit configured to acquire an image of a cargo loaded aboard an airplane prior to the arrival of the airplane at an arrival airport;

a characteristics detection unit configured to detect characteristics of the cargo by recognizing the image of the cargo acquired by the image pick-up unit; and

a workload calculation unit configured to calculate a workload required to convey the cargo at the arrival airport by checking the characteristics of the cargo detected by the characteristics detection unit against pre-recorded workload information.

According to an aspect of the present disclosure mentioned above, a workload calculation system capable of suppressing the possibility of the cargo handling work not being performed as planned in the work schedule at the arrival airport is provided.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing an example of a structure of a workload calculation system according to an embodiment;

FIG. 2 is a table showing workload information used in a workload calculation unit of the workload calculation system according to an embodiment; and

FIG. 3 is a flow chart showing a flow of processing performed by the workload calculation system according to this embodiment.

### DESCRIPTION OF EMBODIMENTS

Hereinbelow, the present disclosure will be explained through the embodiments, however, the claims of the present disclosure are not to be limited to the embodiments. Further, not all of the structures described in the embodiments are essential in solving the problem to be solved by the present disclosure. For the sake of clarification, the description and the drawings mentioned below are omitted or simplified as appropriate. In each of the drawings, the same symbols are assigned to the same elements throughout the drawings and duplicated explanations are omitted as appropriate.

A workload calculation system according to this embodiment is a system for calculating a workload required to convey cargos at an arrival airport where an airplane aboard which cargos such as luggage are loaded in bulk arrives at. Note that the cargos loaded in bulk aboard an airplane are also referred to as bulk cargos.

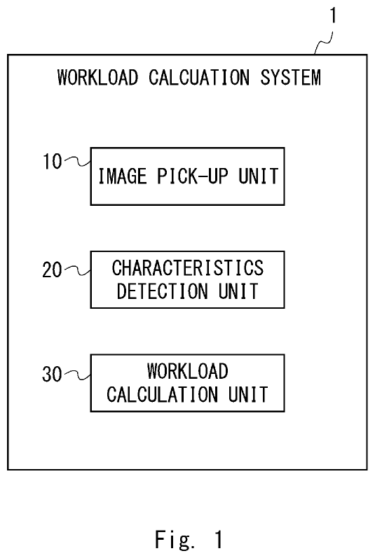

First, an example of a workload calculation system 1 according to this embodiment is explained with reference to FIG. 1. As shown in FIG. 1, the workload calculation system 1 according to this embodiment includes an image pick-up unit 10, a characteristics detection unit 20, and a workload calculation unit 30.

The image pick-up unit 10 acquires an image of the cargos that are loaded aboard an airplane before the arrival of the airplane at the arrival airport. For example, the image pick-up unit 10 is realized by a camera such as a fixed camera, a PTZ (Pan Tilt Zoom) camera, or the like. Further, the image pick-up unit 10 may be disposed at a departure airport of the airplane and may acquire an image of the cargos before they are loaded aboard the airplane. Specifically, the image pick-up unit 10 may be disposed at a sorting room where the cargos are sorted into respective airplanes and may acquire an image of the cargos while they are placed on a belt conveyor in the sorting room. Alternatively, the image pick-up unit 10 may be disposed inside the airplane and acquire an image of the cargos after the cargos are loaded aboard the airplane. To be more specific, the image pick up unit 10 may, for example, be disposed in a bulk cargo compartment into which cargos are loaded in bulk and pick up an image of the cargos that have been loaded in a bulk state.

The characteristics detection unit 20 detects characteristics of a cargo by recognizing an image of the cargo acquired by the image pick-up unit 10. The characteristics of a cargo are, for example, the shape of the cargo etc. Here, a general image recognition technique can be employed for the image recognition processing performed by the characteristics detection unit 20. For example, the image recognition processing may be performed by creating and using a learned model that has learned the image by machine learning.

The workload calculation unit 30 calculates the workload required to convey a cargo at the arrival airport by checking the characteristics of the cargo detected by the characteristics detection unit 20 against the pre-recorded workload information.

Here, in general, the cargos that are bulk-loaded in the bulk cargo compartment disposed inside the airplane that has arrived at the arrival airport are conveyed in the following manner. First, the cargos loaded aboard the airplane are placed on a belt loader by a worker and unloaded from the airplane. Next, the cargos placed on the belt loader are loaded on a conveyance vehicle such as a cargo truck by a worker and conveyed to the sorting room. Then, the cargos that are loaded on the conveyance vehicle are placed on the belt conveyor disposed inside the sorting room by a worker and conveyed to the baggage claim etc.

The workload calculated by the workload calculation unit 30 can be arbitrary determined by where the cargos are to be conveyed. For example, the workload calculation unit 30 may calculate the workload of conveying the cargos from inside the airplane to the conveyance vehicle, or may calculate the workload of conveying the cargos from inside the airplane to the sorting room.

Further, the workload calculated by the workload calculation unit 30 may be the working time required to convey the cargos or may be the number of workers required to convey the cargos. Further, if a work vehicle such as the aforementioned conveyance vehicle is necessary for conveying the cargos, the workload may be the type of the work vehicle or the number of the work vehicles.

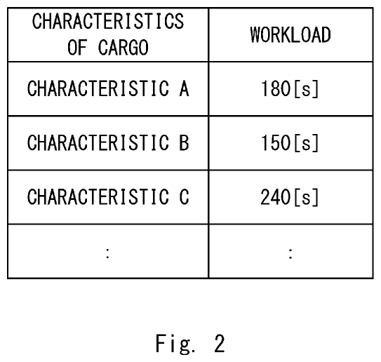

Further, the workload information pre-recorded in the workload calculation unit 30 is information indicating the workload that is required to convey the cargos at the arrival airport depending on the characteristics of each cargo. FIG. 2 shows an example of the workload information. In the example shown in FIG. 2, the workload information shows the working time [s] as the workload of conveying the cargos from inside the airplane to the conveyance vehicle. In the example shown in FIG. 2, for example, when the characteristics detection unit 20 detects a characteristic A of the cargo, the workload calculation unit 30 calculates the working time 180 [s] for handling the characteristic A as the workload of the cargo. As understood from the example shown in FIG. 2, the workload required to convey the cargos at the arrival airport differs largely depending on the characteristics of each cargo.

Note that the characteristics detection unit 20 and the workload calculation unit 30 may be disposed at the arrival airport. In this case, the characteristics detection unit 20 may acquire an image of the cargo from the image pick-up unit 10 by performing wireless communication with the image pick-up unit 10. However, the location where the characteristics detection unit 20 and the workload calculation unit 30 are disposed is not necessarily limited to the arrival airport. For example, the characteristics detection unit 20 and the workload calculation unit 30 may be disposed at a location that is away from the arrival airport or the departure airport. In this case, the workload calculation unit 30 may transmit the result of calculation of the workload by performing wireless communication with a terminal (not shown) disposed at the arrival airport.

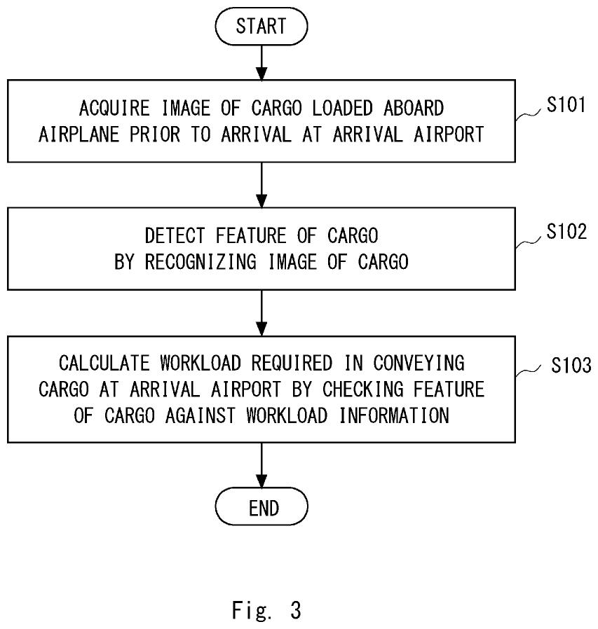

Next, a flow of processing performed by the workload calculation system 1 according to this embodiment is explained with reference to FIG. 3.

As shown in FIG. 3, first, the image pick-up unit 10 acquires an image of a cargo loaded aboard an airplane prior to the arrival of the airplane at the arrival airport (Step S101). Next, the characteristics detection unit 20 detects the characteristics of the cargo by recognizing an image of the cargo acquired by the image pick-up unit 10 (Step S102). Then, the workload calculation unit 30 calculates the workload required to convey the cargo at the arrival airport by checking the characteristics of the cargo detected by the characteristics detection unit 20 against the pre-recorded workload information (Step S103).

Next, the effect of the workload calculation system 1 according to this embodiment is explained. Conventionally, at an arrival airport, the amount of workload required to convey cargos loaded aboard the arriving airplane has been estimated manually and the work schedule has been planned based on the estimated cargo handling amount.

However, in the case of an airplane aboard which the cargos are loaded in bulk, when the characteristics such the shape etc. of the cargos vary largely, an unexpected amount of workload is required at the arrival airport depending on the characteristics of each cargo. Therefore, there has been a possibility that the cargo handling work is not performed as planned in the work schedule at the arrival airport.

Accordingly, in the workload calculation system 1 according to this embodiment, the workload required to convey a cargo at the arrival airport is calculated by acquiring an image of the cargo loaded aboard an airplane and detecting characteristics of the cargo from the acquired image of the cargo and checking the characteristics of the cargo against the pre-recorded workload information.

By this structure, the workload required to convey the cargo can be calculated in accordance with the characteristics of the cargo. Therefore, it is possible to suppress an unexpected workload from being generated at the arrival airport since it is possible to plan a work schedule based on the workload calculated as described above. As a result, it is possible to suppress the possibility of the cargo handling work not being performed as planned in the work schedule at the arrival airport.

Note that the present disclosure is not limited to the embodiments described above and can be modified as appropriate without departing from the gist of the present disclosure.

For example, the present disclosure can be applied not only to an airplane aboard which all of the cargos are loaded in bulk but also to an airplane aboard which some of the cargos are loaded in bulk and the rest of the cargos are loaded in a container or on a pallet. In the case of an airplane aboard which some of the cargos are loaded in bulk, the workload of the cargos that are loaded in bulk among the cargos that are loaded aboard the airplane can be calculated utilizing the present disclosure.

Further, in the above-described embodiments, the workload calculation system according to the present disclosure has been described as a hardware configuration, but the present disclose is not limited thereto. In the present disclosure, any processing of the workload calculation system can be achieved by a processor, such as a CPU (Central Processing Unit), loading and executing a computer program stored in a memory.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A workload calculation system comprising:
an image pick-up unit configured to acquire an image of a cargo loaded aboard an airplane prior to the arrival of the airplane at an arrival airport;
a characteristics detection unit configured to detect characteristics of the cargo by recognizing the image of the cargo acquired by the image pick-up unit; and
a workload calculation unit configured to calculate a workload required to convey the cargo at the arrival airport by checking the characteristics of the cargo detected by the characteristics detection unit against pre-recorded workload information.

2. The workload calculation system according to claim 1, wherein the workload information is information indicating, for each characteristic, the workload required to convey the cargo having the characteristics at the arrival airport.

3. The workload calculation system according to claim 1, wherein the characteristics detection unit detects a shape characteristic of the cargo.

4. The workload calculation system according to claim 1, wherein the image pick-up unit is disposed at a departure airport of the airplane or inside the airplane.
